(19) United States
(12) Patent Application Publication
(10) Pub. No.: US 2014/0017646 A1
(43) Pub. Date: Jan. 16, 2014

(54) SYSTEM AND METHOD FOR RECEIVING AND PROVIDING ANONYMOUS CHARACTER FEEDBACK

(71) Applicants: Robert C. Seitzberg, III, Phoenix, AZ (US); Gabriel L. Mulkhern-Fenton, Conway, NV (US); Casey L. Fenton, San Francisco, CA (US); Sebastien LeTuan, San Jose, CA (US)

(72) Inventors: Robert C. Seitzberg, III, Phoenix, AZ (US); Gabriel L. Mulkhern-Fenton, Conway, NV (US); Casey L. Fenton, San Francisco, CA (US); Sebastien LeTuan, San Jose, CA (US)

(21) Appl. No.: 13/940,139

(22) Filed: Jul. 11, 2013

Related U.S. Application Data
(60) Provisional application No. 61/670,588, filed on Jul. 11, 2012.

(51) Int. Cl. G09B 19/00

(52) U.S. Cl. CPC G09B 19/00
USPC 434/236

(57) ABSTRACT

A system and method provides users a place to provide feedback to another person about how they rate the person on different character traits and or abstract ideas. Particular embodiments of the present invention provide a system and method over the internet for enticing people to answer a question about another person to provide anonymous feedback. The system and method provides anonymity such that persons providing feedback are more truthful because they don't feel pressure to answer a question the way they think the person (or other individual) receiving the results wants them to answer.

### CLAIM OF PRIORITY

The present application claim priority to U.S. Provisional Application No. 61/670,588 filed Jul. 11, 2012 which provisional application is hereby incorporated herein by reference.

### FIELD OF THE INVENTION

The current invention relates to personal knowledge and development and more specifically to systems and methods for assessment of character through feedback.

### BACKGROUND

The current invention relates to personal knowledge and development and more specifically to systems and methods for assessment of character through feedback from other persons.

It would be desirable to provide users a place to provide feedback to another person about how they rate the person on different character traits and or abstract ideas.

It would further be desirable to provide anonymity so that users won't feel pressure to answer a question the way they think the person (or other individuals who may see the results) wants them to answer and therefore achieve more truthful reporting.

### SUMMARY

Embodiments of the present invention provide users a place to provide feedback to another person about how they rate the person on different character traits and or abstract ideas.

Embodiments of the present invention provide anonymity so that users won't feel pressure to answer a question the way they think the person (or other individuals who may see the results) wants them to answer and therefore achieve more truthful reporting.

One purpose of embodiments of the invention is to provide users a place to provide feedback to another person about how they rate the person on different character traits and or abstract ideas. Because of the anonymity, persons providing feedback are more truthful because they don't feel pressure to answer a question the way they think the person (or other individual) receiving the results wants them to answer.

Particular embodiments of the present invention provide a service which relays information from one user on a website/service or a social networking site to one of their immediate connections on the website/service or another social networking site without revealing the identity of the user who relayed that information.

Particular embodiments of the present invention provide a system and method for enticing people to answer a question about another person to provide anonymous feedback.

Embodiments of the present invention provide a system and method that allows a user to compare received feedback to how they see themselves.

In particular embodiments of the present invention a user does not receive the feedback until they answered the question about another user.

In particular embodiments of the present invention a user can answer a question for multiple people at the same time.

In particular embodiments of the present invention the system and method operates over the internet.

In particular embodiments of the present invention the system and method provides for calculation of feedback results.

Other objects and advantages of the present invention will become apparent to those skilled in the art from the following detailed description of the various embodiments, when read in light of the accompanying drawings.

### BRIEF DESCRIPTION OF THE DRAWINGS:

FIG. 1 shows a character feedback system according to an embodiment of the invention.

FIG. 2 shows a character feedback method according to an embodiment of the invention.

FIG. 3 shows a character feedback loop according to an embodiment of the invention.

### DETAILED DESCRIPTION

In the following description, the invention will be illustrated by way of example and not by way of limitation in the figures of the accompanying drawings. References to various embodiments in this disclosure are not necessarily to the same embodiment, and such references mean at least one. While specific implementations are discussed, it is understood that this is provided for illustrative purposes only. A person skilled in the relevant art will recognize that other components and configurations may be used without departing from the scope and spirit of the invention.

Furthermore, in certain instances, numerous specific details will be set forth to provide a thorough description of the invention. However, it will be apparent to those skilled in the art that the invention may be practiced without these specific details. In other instances, well-known features have not been described in as much detail so as not to obscure the invention.

Common reference numerals are used to indicate like elements throughout the Figures and detailed description; therefore, reference numerals used in a Figure may or may not be referenced in the detailed description specific to such figure if the element is described elsewhere. The first digit in a three digit reference numeral indicates the series of Figures in which the element first appears.

Although the Figures depict components as logically separate, such depiction is merely for illustrative purposes. It will be apparent to those skilled in the art that the components portrayed in this figure can be combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

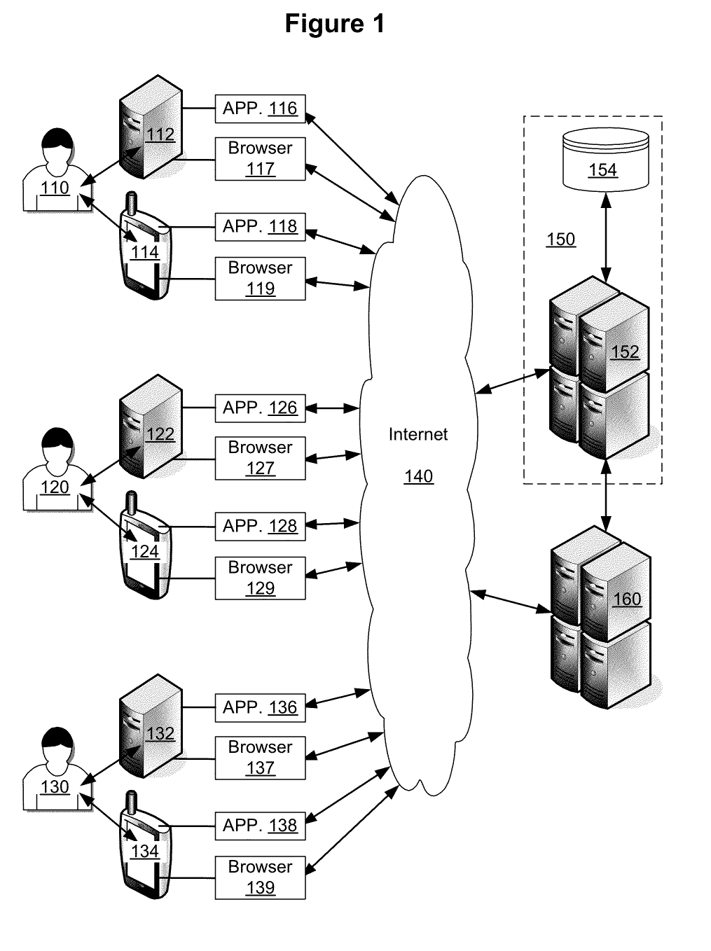

FIG. 1 shows a character feedback system 150 according to an embodiment of the invention. Character feedback system 150 includes character feedback server 152 and database 154. Character feedback system 150 is connected by the Internet 140 and/or a telecommunications network to a plurality of users 110, 120, 130. Character feedback system 150 is also connected to social network 160 either directly or via Internet 140. Social network 160 includes contact data identifying social connections between one user and other users in the form of a contact list, friend list or the like. One example of a suitable social network is the FACEBOOK® social network. Character feedback system may interact with multiple different social networks and/or sources of contact information.

A social network refers in general to a social structure made up of entities, such as individuals or organizations, which are connected by one or more types of interdependency or relationships, such as friendship, kinship, common interest, financial exchange, dislike, or relationships of beliefs, knowledge, or prestige. There are social-networking systems existing on the Internet in the form of social-networking websites. Such social-networking websites enable their members, who are commonly referred to as website users, to perform various social activities. For example, the FACEBOOK® at www.facebook.com enables its users to communicate with their friends via emails, instant messages, or blog postings, organize social events, share photos, receive news of their friends or interesting events, play games, etc.

Character feedback system 150 utilizes data from social network 160 as authorized by the user. Character feedback system 150 retrieves consenting user's list of connections in order to contact those persons and request anonymous feedback. Particular embodiments of the character feedback system 150 provide a service which relays information from one user on a website/service or a social networking site to one of their immediate connections on the website/service or another social network 160 without revealing the identity of the user who relayed that information.

One purpose of Character feedback system 150 is to provide users a place to provide feedback to another person about how they rate the person on different character traits and or abstract ideas. The system entices people to answer a question about another person to provide anonymous feedback. In particular embodiments of the present invention a user does not receive the feedback until they answered the question about another user.

Character feedback system 150 maintains anonymity for the persons providing feedback and character results are delivered to users via character feedback system 150. Because of the anonymity, persons providing feedback are more truthful because they don't feel pressure to answer a question the way they think the person (or other individual) receiving the results wants them to answer.

Character Feedback system 150 interacts with users using a client-server environment. A client associated with a user may receive services from a server over a computer network. Examples of the client devices include, but not limited to, desktop computers, notebook computers, netbook computers, smart phones, personal digital assistants (PDA), tablets, etc. These clients are able to connect to a computer or communications network, such as the Internet or a mobile telephone network, and access and communicate with the servers that are also connected to the network using various suitable communications protocols. A client is thus able to transmit data to and receive data from a server over the network.

Users may install a variety of native applications and/or web-based applications on a computing device (such as smartphones, netbooks, and the like) that access one or more sensors or other input/output devices of the computing device (such as Global Positioning System (GPS) chips, cameras, accelerometers, and the like) and provide services to users.

In particular embodiments, a computing device associated with a user, in response to the user attempting to interact with an application, presents to the user a permissions interface requesting permission to run the application on the computing device. The permissions interface comprises a list that includes one or more hardware components of the computing device, one or more user data elements associated with the user stored on the computing device or remotely from the computing device at one or more remote hosts that the application requests access. The computing device receives a response from the user with respect to the list; and if the response grants the application access to the hardware and data resources identified on the list, grants the application access to those resources. In a particular example the data resources include a list of the user's contacts.

Additionally, the computer device can transmits the user's authorization to one or more remote hosts (such as a social network) to allow such remote hosts to receive indication of such authorization and thereafter allow future access requests transmitted by the application executed on the computer device. In some implementations, the data resources associated with the user may be social network data, such as user profile data associated with the user including but not limited to user contact information, contact information, pictures, and other multimedia associated with the user.

As shown in FIG. 1, first user 110 may access character feedback system 150 and or social network 160 utilizing an application 116 or browser 117 operating on a personal computer 112. Alternatively or additionally, first user 110 may access character feedback system 150 and or social network 160 utilizing an application 118 or browser 119 operating on a mobile phone 114 (or other mobile computing hardware). Second user 120 may access character feedback system 150 and or social network 160 utilizing an application 126 or browser 127 operating on a personal computer 122. Alternatively or additionally, second user 120 may access character feedback system 150 and or social network 160 utilizing an application 128 or browser 129 operating on a mobile phone 124 (or other mobile computing hardware). Third user 130 may access character feedback system 150 and or social network 160 utilizing an application 136 or browser 137 operating on a personal computer 132. Alternatively or additionally, third user 130 may access character feedback system 150 and or social network 160 utilizing an application 138 or browser 139 operating on a mobile phone 134 (or other mobile computing hardware). Three users are shown for illustrative purpose, however it is envisioned that the system interact with many users for examples thousands, hundreds of thousand, and/or millions of users.

A user may use and interact with software applications through the client device. In general, there are two categories of software applications: native applications and web-based applications. A native application typically is one that resides and executes on the client device itself (e.g., within the environment provided by the operating system of the client device). A native application usually needs to be installed on a client device before it may be executed on that client device, and executes within the context of an operating system of the client device. In contrast, a web-based application typically is one that executes within the context of a browser client or other software that utilizes a browser engine. The web-based application usually provides a web-based user interface, which may be accessed by the client device (e.g., through a web browser executing on the client device), and a user of the client device may interact with the web-based application through this web-based user interface. There are many types of web-based applications. An example web-based application may involve a social-networking system hosting a social-networking website that transmits structured documents (e.g., HTML pages) with references to one or more code modules that are operative to execute within the context of a browser client.

Accordingly, users 110, 120, 130 access character feedback system 150 through a web browser 117, 119, 127, 129, 137, 139 or application 116, 118, 126, 128, 136, 138 on their personal computer 112, 122, 132 or mobile device 114, 124, 134 which communicates with character feedback server 152 over the Internet. With user permission, character feedback server 152 gains access to the social network 160 (or site internal to character feedback system 150) of which the user is a member. Character feedback server 152 stores user contact information in database 154.

Character feedback server 152 presents questions for a user, for example first user 110 to answer on a web page (viewable through a web browser or app on first user's personal computer or mobile device) about their connections (for example second user 120). Responses are transmitted to character feedback server 152 and stored in database 154. Character feedback server 152 uses the information it has stored in database 154 to send a notification to second user 120 via social network 160 (or an internal notification if second user 120 is already accessing character feedback server 152). The server forwards a notification to the user who had a question answered about them (for example second user 120).

Second user 120 accesses this notification from the social network 160 (or directly through character feedback server 152 via a web browser or application. The notification includes a link which takes the second user 120 to a web page (viewable through a web browser or app on a user's personal computer or mobile device) that asks the second user to character feedback server 152 to access personal information about them from the social network 160 (or character feedback server 152) and store it in database 154 and/or have the user agree to certain privacy policies.

After the second user 120 allows access they will be directed to a web page served to them from character feedback server 152 (viewable through a web browser or app on a user's personal computer or mobile device) that will display a question/questions for the user to answer about one or more of their connections on a social networking site (or an internal site provided by character feedback system 150) for example third user 130. Second user 120 can now answer questions on that web page about their connections (such as first user 110 or third user 130) whose information the second user 120 authorized the character feedback server 152 to access and that is stored in database 154 or accessed directly from social network 160. One purpose of character feedback system 150 is to provide users a place to provide feedback to another person about how they rate the person on different character traits and or abstract ideas. The system entices people to answer a question about another person to provide anonymous feedback.

These steps are repeated with each user and subsequent users. Once a user has answered a question for a certain number (one or more) of their connections then they will be able to see their results; that is they will be able to see the answers to questions about them. In this way the user is encouraged to provide answers to questions about other users and other users are encouraged to access character feedback server 152 and authorize access to their contacts.

Embodiments of the present invention provide a system and method that allows a user to compare received feedback to how they see themselves. In particular embodiments of the present invention the system and method provides for calculation of feedback results. The system entices people to answer a question about another person to provide anonymous feedback. For example, in particular embodiments of the present invention the system does not display a user's feedback regarding a particular question until they answer the same question about another user.

The first user 120 is as a person who is a member of character feedback system 150 or a social network (e.g. FACEBOOK® or another social network that has the ability to share personal information with character feedback system 150, if the first user 120 agrees to share that information) and has already authorized us to access their personal information.

A notification in the diagram above could include any type of notification sent internally from character feedback system 150 or through a social networking site. For example, a FACEBOOK® notification, a FACEBOOK® Email message through the internal FACEBOOK® messaging system, a regular Email message or any other messaging system internally through a social networking site or externally through another Email messaging system.

The second user 120 refers to any of the immediate connections of first user 110 on character feedback system 150 or a social networking site whose info character feedback system 150 obtained with their permission by accessing that information on the social networking sites servers, and which character feedback system 150 stored in database 154 or that accessed directly with the users permission.

The third user 130 refers to other users (3+) that have immediate connections with second user 120 on character feedback system 150 or another social networking site, and whose information the system obtained with the second user's permission, by accessing that information on character feedback system 150 or a social network 160 and then stored in database 154 or accessed directly with the user's permission.

Questions are designed to obtain answers from a user regarding how they rate the person on different character traits and or abstract ideas.

Anonymous refers to masking the identity of the person (user) who answers questions about their connections (internally on character feedback system 150 and/or on whatever social networking site whose info from which information was obtained with their permission. The identity of the person (user) who answered questions will always remain secret and will never be revealed to the person about whom questions were answered (or to other users. One purpose of embodiments of the invention is to provide users a place to provide feedback to another person about how they rate the person on different character traits and or abstract ideas. Because of the anonymity, persons providing feedback are more truthful because they don't feel pressure to answer a question the way they think the person (or other individual) receiving the results wants them to answer.

In particular embodiments of the present invention the system and method provides for calculation of feedback results. Character feedback system 150 provides for collecting many user responses, combining in an algorithmic way, and averaging them in a way to increase anonymity. The system allows a user to compare received feedback to how they see themselves.

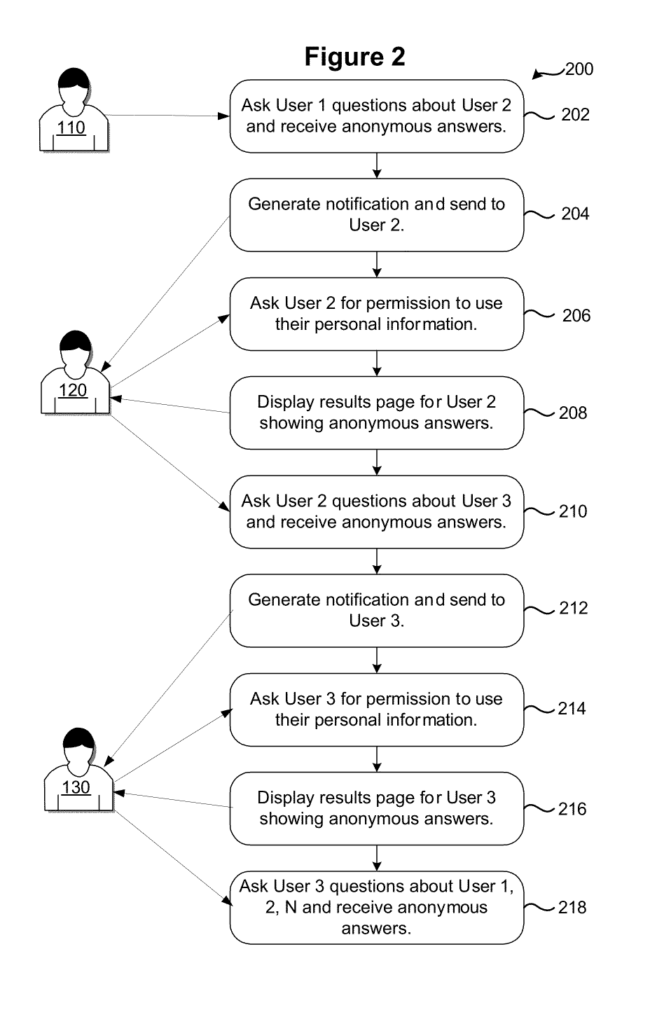

FIG. 2 shows a character feedback method 200 according to an embodiment of the invention. An existing user of character feedback system 150 (first user 110) answers a question about second user 120. Optionally, the first user 110 can answer a question for multiple people at the same time. Character feedback server 152 generates a notification for second user 120. Second user 120 receives an anonymous notification (generated when one of their friends answered a question about them) which has wording to entice the user to access character feedback system 150. Second user 120 is directed to allow character feedback system 150 to access their personal info from a social network 160 (for example FACEBOOK®).

After allowing access to character feedback system 150, second user 120 is redirected to a web page with results on it (at top or on the side, etc.) Second user 120 can view their anonymous results. Second user 120 can then answer this question for their friends (e.g. third user 130 and other users) anonymously. Third (or more) user 130 then receives notification from character feedback system 150. Third user 130 then goes through the same steps as second user 120. The process is thus repeated for the third and subsequent users encouraging persons to become users of character feedback system 150 and share contact information and character information about their contacts.

As shown in FIG. 2, at step 202, character feedback system 150 asks first user 110 questions about second user 120. First user 110 provides anonymous answers to the questions. At step 204, character feedback system 150, generates a notification and sends it to second user 120. At step 206, character feedback system 150 asks second user 120 for permission to use their personal information, including, for example a contacts or friends list. At step 208, when second user has granted permission, character feedback system 150 displays a results page for second user 120 showing the anonymous answers provided by e.g. first user 110.

As shown in FIG. 2, the process is repeated for a third and many subsequent users. At step 210, character feedback system 150 asks second user 120 questions about third user 130. Second user 120 provides anonymous answers to the questions. Optionally, the second user 120 can answer a question for multiple people at the same time.

At step 212, character feedback system 150, generates a notification and sends it to third user 130. At step 214, character feedback system 150 asks third user 130 for permission to use their personal information, including, for example a contacts or friends list. At step 216, when third user 130 has granted permission, character feedback system 150 displays a results page for third user 130 showing the anonymous answers provided by e.g. second user 120. The process can then be repeated for further users in a viral manner.

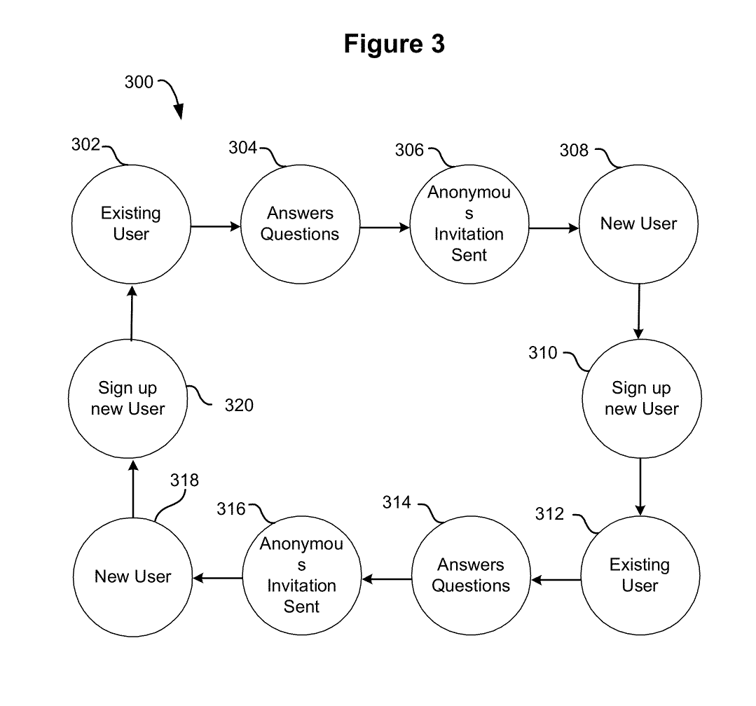

FIG. 3 shows a character feedback loop 300 according to an embodiment of the invention. Character feedback loop 300 is implemented by character feedback system 150 interacting with a plurality of users. As shown in FIG. 3, character feedback loop 300 begins at step 302 with an existing user of character feedback system 150. At step 304, the existing user is posed character questions to answer, and answers the questions about contacts/friends of the existing user. Optionally, the existing user can answer a question for multiple people at the same time. At step 306, based on the answers to the questions, an invitation is sent to the person(s) about whom the questions were answered. The invitation is sent anonymously in that the existing user is not identified.

At step 308, the new user responds to the invitation. At step 310, the character feedback system 150 signs up the new user. At step 312, the new user therefore becomes an existing user. The cycle then repeats. As shown in FIG. 3, character feedback loop 300 continues at step 312 with the newly signed up existing user of character feedback system 150. At step 314, the existing user is posed character questions to answer, and answers the questions about contacts/friends of the existing user. Optionally, the existing user can answer a question for multiple people at the same time. At step 316, based on the answers to the questions, an invitation is sent to the person(s) about whom the questions were answered. The invitation is sent anonymously in that the existing user is not identified.

At step 318, the next new user responds to the invitation. At step 3200, the character feedback system 150 signs up the next new user. The new user therefore becomes an existing user and the loop continues again with step 302. The process can then be repeated for further users in a viral manner.

Appropriate software can readily be prepared by programmers in an available language for operation on a suitable operating system based on the teachings of the present disclosure, as will be apparent to those skilled in the software art. Software may be programmed for operation on various hardware devices, including, but not limited to, laptops, personal computers, wearable computer products, networks of computers, servers, clusters, mobile devices and the like. Embodiments of the invention may also be implemented by the preparation of dedicated hardware components or by interconnecting an appropriate network of conventional hardware components, as will be readily apparent to those skilled in the art.

The various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, hard drives, magneto-optical disks, holographic storage, ROM, RAM, flash memory devices, and any type of media or device suitable for storing instructions and/or information. The computer program product can be transmitted in whole or in parts and over one or more public and/or private networks. In accordance with certain embodiments, however, the computer storage medium containing the instructions is non-transitory (i.e. not in the process of being transmitted) but rather is persisted on a physical device.

In particular embodiments, one or more computer program product and storage media embody software. Software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Pen, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present invention is not limited to the specifically disclosed embodiments, and variations and modifications may be made without departing from the scope of the invention. Also, variations of the present invention may be formed by appropriately combining multiple functional elements disclosed in the above-described embodiments. For example, one or more functional elements may be deleted from the entire functional elements illustrated in the embodiments. Alternatively, functional elements are selected from different embodiments and appropriately combined. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A method for assessment of character of a user through feedback from others, the method comprising:
posing a first question of character to a first person about a second person;
receiving a first answer from said first person;
sending the second person a notification of said first answer;
inviting the second person to share contact information in order to view said first answer; and
if the second person consents to share contact information, displaying the first answer in a manner that maintains anonymity for the first person.

2. The method of claim 1, further comprising:
posing a second question of character to the second person about a third person from identified in the contact information of the second person;
receiving a second answer from said second person;
sending the third person a notification of said second answer;
inviting the third person to share contact information in order to view said second answer; and
if the third person consents to share contact information, displaying the second answer in a manner that maintains anonymity for the second person.

3. The method of claim 1, wherein:
said posing step comprises posing a first question of character to the first person about a plurality of second persons.

4. The method of claim 1, wherein:
said posing step comprises posing a first question of character to the first person about a plurality of second persons;
said receiving step comprises receiving a plurality of first answers from said first person about a plurality of second persons; and
said sending step comprises sending each of the plurality of second persons a notification of a corresponding answer of said plurality of first answers.

5. The method of claim 1, further comprising displaying received responses to the first question answered about the first person only after receiving from said first person a first answer to the first question about said second person.

6. A non-transitory computer readable storage medium including instructions stored thereon for providing a system for assessment of character of a user through feedback from others, wherein said instructions cause the computer to perform a method comprising the steps of:
posing a first question of character to a first person about a second person;
receiving a first answer from said first person;
sending the second person a notification of said first answer;
inviting the second person to share contact information in order to view said first answer; and
if the second person consents to share contact information, displaying the first answer in a manner that maintains anonymity for the first person.

7. The non-transitory computer readable storage medium of claim 6, wherein said instructions cause the computer to perform a method comprising the steps of:
posing a second question of character to the second person about a third person from identified in the contact information of the second person;
receiving a second answer from said second person;
sending the third person a notification of said second answer;
inviting the third person to share contact information in order to view said second answer; and
if the third person consents to share contact information, displaying the second answer in a manner that maintains anonymity for the second person.

8. The non-transitory computer readable storage medium of claim 6, wherein said posing step comprises posing a first question of character to the first person about a plurality of second persons.

9. The non-transitory computer readable storage medium of claim 6, wherein said posing step comprises posing a first question of character to the first person about a plurality of second persons;
said receiving step comprises receiving a plurality of first answers from said first person about a plurality of second persons; and
said sending step comprises sending each of the plurality of second persons a notification of a corresponding answer of said plurality of first answers.

10. The non-transitory computer readable storage medium of claim 6, wherein said instructions cause the computer to perform a method comprising the steps of:
displaying received responses to the first question answered about the first person only after receiving from said first person a first answer to the first question about said second person.

11. A character feedback system comprising:
a character feedback server and a database;
wherein the character feedback system is adapted for
posing a first question of character to a first person about a second person;
receiving a first answer from said first person,
sending the second person a notification of said first answer,
inviting the second person to share contact information in order to view said first answer, and
if the second person consents to share contact information, displaying the first answer in a manner that maintains anonymity for the first person.

12. The character feedback system of claim 11, wherein the character feedback system is adapted for:
posing a second question of character to the second person about a third person from identified in the contact information of the second person;
receiving a second answer from said second person;
sending the third person a notification of said second answer;
inviting the third person to share contact information in order to view said second answer; and
if the third person consents to share contact information, displaying the second answer in a manner that maintains anonymity for the second person.

13. The character feedback system of claim 11, wherein said posing step comprises posing a first question of character to the first person about a plurality of second persons.

14. The character feedback system of claim 11, wherein:
said posing step comprises posing a first question of character to the first person about a plurality of second persons;
said receiving step comprises receiving a plurality of first answers from said first person about a plurality of second persons; and
said sending step comprises sending each of the plurality of second persons a notification of a corresponding answer of said plurality of first answers.

15. The character feedback system of claim 11, wherein the character feedback system is adapted for:
displaying received responses to the first question answered about the first person only after receiving from said first person a first answer to the first question about said second person.
